(19) United States
(12) Patent Application Publication
(10) Pub. No.: US 2026/0051735 A1
(43) Pub. Date: Feb. 19, 2026

(54) METHODS AND DEVICES FOR MANAGING DATA COMMUNICATION IN AN ELECTRICAL POWER SYSTEM

(71) Applicant: BLUWAVE INC., Ottawa (CA)

(72) Inventors: Minming NI, Ottawa (CA); Thomas TRIPLET, Ottawa (CA); Craig DOWNING, Ottawa (CA); Devashish PAUL, Ottawa (CA)

(21) Appl. No.: 18/806,264

(22) Filed: Aug. 15, 2024

(51) Int. Cl. H02J 3/00

(52) U.S. Cl. CPC H02J 3/007; H02J 3/003

(57) ABSTRACT

Disclosed herein are systems and methods for managing communication with an electrical power system. A load curtailment plan is received. The load curtailment plan implements a load curtailment request from an electrical system operator. The load curtailment plan includes a plurality of action requests corresponding to one or more disparate end user assets. The action requests are translated for communication in accordance with a plurality disparate protocols used by the one or more disparate end user assets. The translated action requests are transmitted to the one or more disparate end user assets.

### FIELD

This disclosure relates to electrical power systems, and more particularly relates to data communication within an electrical power system.

### BACKGROUND

Electrical power systems encompass infrastructure for generating, transmitting, and distributing electricity from power plants to end users. The stability and efficiency of these systems depend on load management, aimed at matching the electricity supply with the consumption patterns of various end users.

Effective load management ensures the reliability of the power system, prevents outages, and maintains a desired balance between demand and supply. One strategy within load management is load curtailment, which involves reducing power usage during peak demand periods or when supply constraints arise. Curtailment is typically orchestrated by electrical system operators, such as, for example, the Independent Electricity System Operator (IESO), through cooperation with electrical utilities and end users.

In times of high demand or when the integrity of the electrical grid is at risk, strategically lowering the demand through curtailment can prevent overloading of the grid, minimize the need for expensive peak-time generation, and foster a more sustainable energy landscape.

In an electrical power system with diverse end users and needs, implementing curtailment presents various challenges.

### SUMMARY

In accordance with an aspect, there is provided a computer-implemented system for managing data communication in an electrical power system. The system includes a communication subsystem including one or more network interfaces for communication via one or more communication networks; and a processing subsystem that includes one or more processors and one or more memories coupled with the one or more processors. The processing subsystem is configured to cause the system to: provide a translation layer for translating communications according to a plurality disparate protocols used by a plurality of disparate end user assets; receive a load curtailment plan to implement a load curtailment request from an electrical system operator, the load curtailment plan including a plurality of action requests corresponding to at least one of the disparate end user assets; translate the action requests using the translation layer; and transmit the translated action requests, via the communication subsystem, to the at least one of the disparate end user assets.

In such system, the translation layer may be configured to translate communications with a plurality of the electrical system operators.

In such system, the translation layer may be configured to translate communications with a plurality of electrical utilities.

In such system, the translation layer may be configured to translate communications with a plurality of electrical utilities assets.

In such system, the processing subsystem may be further configured to cause the system to receive from electrical system operator a load curtailment request.

In such system, the processing subsystem may be further configured to cause the system to generate the load curtailment plan responsive to the load curtailment request.

In such system, the processing subsystem may be further configured to cause the system to translate, using the translation layer, at least a portion of the load curtailment request for communication to an electrical utility.

In such system, the processing subsystem may be further configured to cause the system to transmit the at least a portion of the load curtailment request, as translated, to the electrical utility via the communication subsystem.

In such system, the processing subsystem may be further configured to cause the system to receive a status update from a given one of the end user assets.

In such system, the plurality of disparate end user assets may include one or more of: disparate types of electric vehicles; disparate types of electric vehicle chargers; disparate types of distributed energy resources; disparate types of smart thermostats; and disparate types of smart home software.

In such system, the translation layer may be further configured to translate communications according to a plurality disparate protocols used by a plurality of disparate electrical utility assets.

In such system, the curtailment plan may further include a plurality of action requests corresponding to one or more disparate electrical utility assets.

In accordance with an aspect, there is provided a computer-implemented method for managing communication with an electrical power system. The method includes receiving a load curtailment plan to implement a load curtailment request from an electrical system operator, the load curtailment plan including a plurality of action requests corresponding to one or more disparate end user assets; translating the action requests for communication in accordance with a plurality disparate protocols used by the one or more disparate end user assets; and transmitting the translated action requests to the one or more disparate end user assets.

Such method may further include receiving from electrical system operator a load curtailment request.

Such method may further include generating the load curtailment plan responsive to the load curtailment request.

Such method may further include translating at least a portion of the load curtailment request for communication to an electrical utility.

Such method may further include transmitting the at least a portion of the load curtailment request, as translated, to the electrical utility.

Such method may further include receiving a status update from a given one of the end user assets.

In such method, the plurality of disparate end user assets may include one or more of: disparate types of electric vehicles; disparate types of electric vehicle chargers; disparate types of distributed energy resources; disparate types of smart thermostats; and disparate types of smart home software.

In such method, the curtailment plan may further include a plurality of action requests corresponding to one or more disparate electrical utility assets.

Many further features and combinations thereof concerning embodiments described herein will appear to those skilled in the art following a reading of the instant disclosure.

### BRIEF DESCRIPTION OF THE DRAWINGS

In the figures,

FIG. 1 is a schematic diagram of an example electrical power system, in accordance with an embodiment;

FIG. 2 is a network diagram of a network environment of an example electrical power system, in accordance with an embodiment;

FIG. 3 is a graph showing relationship of entities of an example electrical power system, in accordance with an embodiment;

FIG. 4 is a schematic diagram of a management system, in accordance with an embodiment;

FIG. 5 is a schematic diagram showing flow of data transmissions to and from an management system, in accordance with an embodiment;

FIG. 6 and FIG. 7 each is a sequence diagram showing interactions between entities of an example electrical power system, in accordance with an embodiment; and

FIG. 8 is a schematic diagram for a computing device, in accordance with an embodiment.

These drawings depict exemplary embodiments for illustrative purposes, and variations, alternative configurations, alternative components and modifications may be made to these exemplary embodiments.

### DETAILED DESCRIPTION

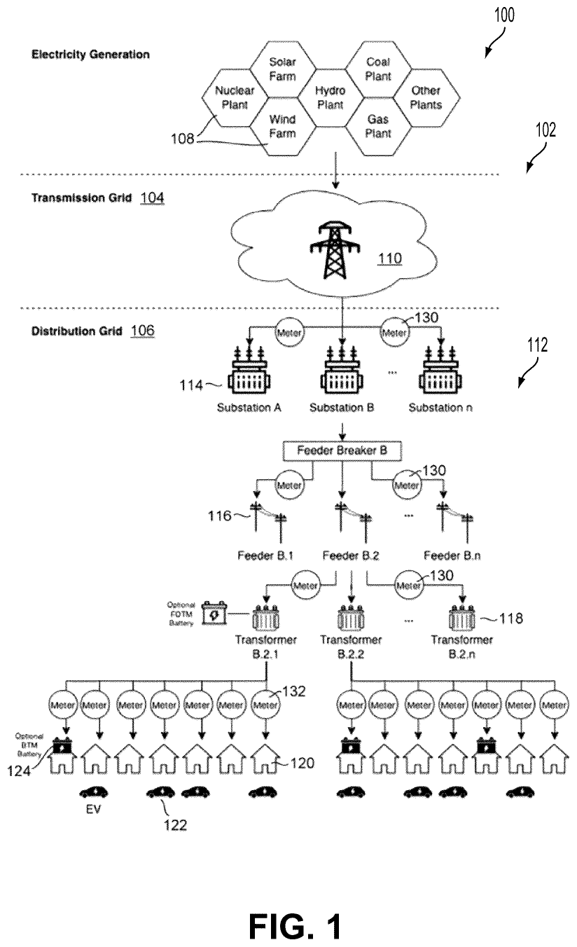

FIG. 1 depicts an example electrical power system 100, in accordance with an embodiment. An electrical power system generally refers to any system that involves the transmission and/or distribution of electrical power. An electrical power system may include a power grid 102, which is generally a network for transmission and distribution from electrical power producers to end users. In addition, an electrical power system may refer to only part of an electrical power grid. However, in general, the terms power system and power grid are used interchangeably herein. Furthermore, an electrical power grid generally refers to any power network or system, and is thus not limited to a conventional power grid.

An electrical power grid may be subdivided into several sub grids, for example a power transmission grid 104 and a power distribution grid 106. A power grid generally comprises one or more power generating plants 108, power transmission infrastructure 110 to carry power long distances, and power distribution infrastructure 112 to deliver power to end users. Power generating plants 108 may include any types of power generation, such as fossil fuel (e.g., coal or gas), nuclear, and renewables such as solar, wind, and so on.

Power distribution infrastructure 112 may include one or more substations 114, for example, for stepping down the voltage from the transmission infrastructure to a lower voltage for the distribution infrastructure. Power distribution infrastructure 112 may include one or more feeders 116, which are electrical conductors, for example, for delivering power from substations 114 to locations further downstream in the distribution infrastructure 112, such as distribution transformers 118. Distribution transformers 118 may further step down the voltage from the feeder lines 116 to a lower voltage, for example for delivery to end users 120. Users 120 may be associated with any type(s) of power customer, for example a home or other building or dwelling. Users 120 may be associated with various equipment such as an electric vehicle (EV) charging station, a charge point, an EV 122, an ESS such as a battery energy storage system (BESS) 124, and so on.

A tree-like structure of the distribution grid 106 may be thought of as having multiple different branches, for example from a substation to various feeders, or from a feeder to various transformers, and so on.

Power system 100 may have electrical meters, for example, distribution meters 130 and/or customer meters 132, at various locations in electrical power system 100. Meters may be used to measure any types of electrical parameters, such as current, voltage, power, and so on.

An example of power system infrastructure being overloaded is now described. Referring to FIG. 1, assume that it around 5 pm on a work day during the summer when many homes are running the electric air conditioners of their homes, and several people in a neighborhood arrive back at home (for example from work) in their EVs 122. In this example, the people in the neighborhood all live at homes that are serviced by transformer B.2.1 in FIG. 1. Upon arrival at home, they connect their EVs 122 to charge points at their homes 120, and the EVs 122 begin charging immediately. The people also turn on various electrical devices in their homes, such as stoves, ovens, and washing machines. The user demand during this on-peak time is very high.

As the users who live in homes serviced by transformer B.2.1 begin to own or use more EVs 122, the load on the subset of the power grid 106 infrastructure that services these people will increase. At a certain point, the number of EVs 122 at these homes will likely reach a point at which the demand (load) will at times exceed the operational limits of electrical components in the subset of the power grid 106 infrastructure that services these users, which includes transformer B.2.1. Exceeding of the operational limits of the component(s) will constitute an overloading of this subset of the power grid 106, thereby potentially causing physical damage to at least some of the electrical components in the power grid 106, possibly including transformer B.2.1.

Load curtailment in electrical generation systems is an operational strategy employed by electrical system operators such as the Independent Electricity System Operator (IESO). This process involves the deliberate reduction in electrical power consumption by end users, especially during peak demand times or when a power grid is threatened by instability or outages.

An objective of load curtailment is to ensure the stability and reliability of the power grid. In moments when demand threatens to exceed the supply, either due to generation limitations or unforeseen demand spikes, curtailment can prevent system-wide blackouts and maintain service for at least some end users.

Curtailment also plays a pivotal role in economic efficiency. By reducing the load strategically, an operator can avoid running more expensive and often less environmentally-friendly auxiliary generation plants, thus saving on costs and minimizing environmental impact. In some markets, load curtailment can also be a part of a demand response program where users bid reductions in a similar manner to suppliers bidding generation capacity. This creates a dynamic system that uses financial signals to manage electrical load actively.

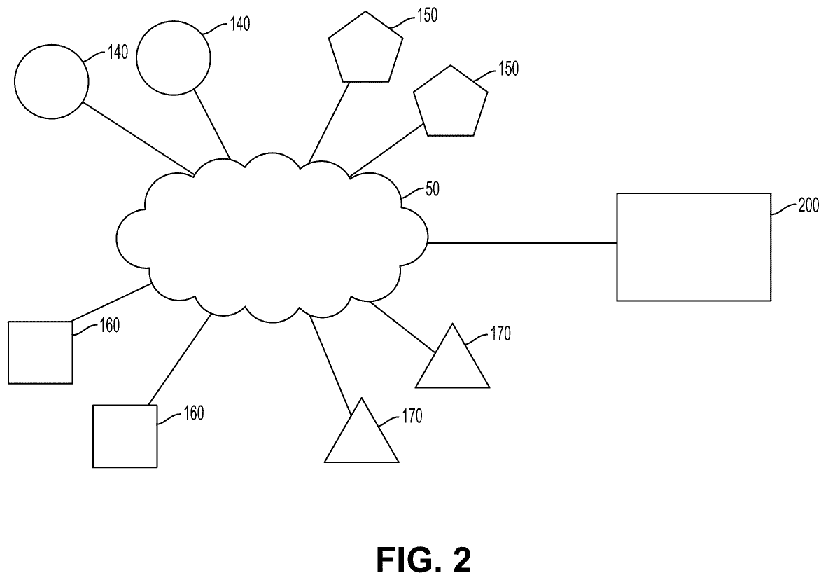

FIG. 2 is a diagram depicting a network environment of an example management system 200 for managing an electrical power system, in accordance with an embodiment. Management system 200 is configured to manage data communication between various entities (e.g., users, operators, utilities, equipment, software, etc.) within an electrical power system. In some embodiments, management of such data communication may be intended to improve stability, reliability, and/or efficiency of an electrical power system.

In some embodiments, data communication between various entities may be for the purpose of coordinating execution of a curtailment or demand and response plan, e.g., for proactively shaping the energy demand, and influencing when and how electricity is consumed.

As depicted, management system 200 is interconnected with a plurality of operator computing devices 140, a plurality of utility computing devices 150, a plurality of electrical utility assets 160, and a plurality of end user assets 170, by way of a communication network 50.

Each operator computing device 140 is operated by an electrical system operator. An operator computing device 140 may communicate with management system 200, e.g., to issue a curtailment request (also known as a demand and response event) to management system 200. A curtailment request may specify that load be reduced by a particular amount in a particular grid (or sub grid) during a particular time interval. An operator computing device 140 may be a computer server device, a personal computer device, a cloud computing device, or the like.

Operator computing devices 140 may include disparate operator computing devices 140 that may communicate by different protocols such as, for example, OpenADR, IEC 62325, or the like.

Each utility computing device 150 is operated by an electrical utility responsible for power distribution in a particular grid. An electrical utility may also be referred to as a local distribution company. A utility computing device 150 may communicate with management system 200 to coordinate the amount of available power, e.g., in response to curtailment requests from an electrical system operator, in response to predictions of demand, and/or other various other factors. A utility computing device 150 may be a computer server device, a personal computer device, a cloud computing device, or the like.

Each electrical utility asset 160 is an equipment or software operated by an electrical utility. For example, electrical utility assets 160 may include various meters (e.g., distribution meters 130 or customer meters 132), front-of-the-meter (FOTM) BESS, transformers, substations, feeders, or the like. Such electrical utility assets 160 may include integrated smart sensors capable of communicating with management system 200, e.g., via network 50.

Utility computing devices 150 may includes disparate utility computing devices 150 and electrical utility assets 160 may include disparate electrical utility assets 160, each of which may communicate by different protocols such as, for example, IEC 870, Modbus, Distributed Network Protocol 3 (DNP3) or the like. The disparate electrical utility assets 160 may be of different types, models, from different vendors, etc.

Each end user asset 170 is an equipment or software operated by an end user. For example, end user assets 170 may include various electric vehicles (e.g., EV 122), electric vehicle chargers, smart thermostats, smart home software, or the like. In some embodiments, an end user asset 170 may also be a personal computing device capable of sending and/or receiving data communication from management system 200 such as, for example, a smart phone, a tablet computer, a laptop computer, a desktop computer, or the like.

End user assets 170 may include disparate end user assets 170 (e.g., of different types, models, from different vendors, etc.) that communicate by different protocols. For example, having regard to communication protocols between charging stations and management systems in EV charging infrastructure, various protocols such as Open Charge Point Protocol (OCPP), Open Charge Point Interface, Modbus, Message Queuing Telemetry Transport (MQTT), or the like, may be used by different vendors. For various end user assets 170, yet other protocols such as those adhering to Smart Energy Profile 2.0 (IEEE 2030.5), IEEE 1547, and IEEE 61850 may also be used. Furthermore, various end user assets 170 may communicate by way of different interfaces such as mobile application interfaces, web application interfaces, application programming interfaces, or the like, which each may use its own protocols or data formats.

In some embodiments, the network environment of an electrical power system may further include computing devices, equipment, and/or software, operated by an operator of a power generating plant 108, which may be connected for intercommunication with other entities within the network environment by way of network 50.

Network 50 may include a packet-switched network portion, a circuit-switched network portion, or a combination thereof. Network 50 may include wired links, wireless links such as radio-frequency links or satellite links, or a combination thereof. Network 50 may include wired access points and wireless access points. Portions of network 50 could be, for example, an IPV4, IPV6, X.25, IPX or similar network. Portions of network 50 could be, for example, a GSM, GPRS, 3G, LTE or similar wireless networks. Network 50 may include or be connected to the Internet. When network 50 is a public network such as the public Internet, it may be secured as a virtual private network.

As is apparent from FIG. 2, in a network with a plurality of electrical system operators, electrical utilities, end users, and various assets (e.g., equipment and software) operated by electrical utilities and end users, the possible relationships and opportunities for coordination are myriad. However, the disparate protocols, data format, and interfaces used by such assets hinder data communication required for such coordination. Difficulty in data communication may be a barrier to growth of an electrical power system.

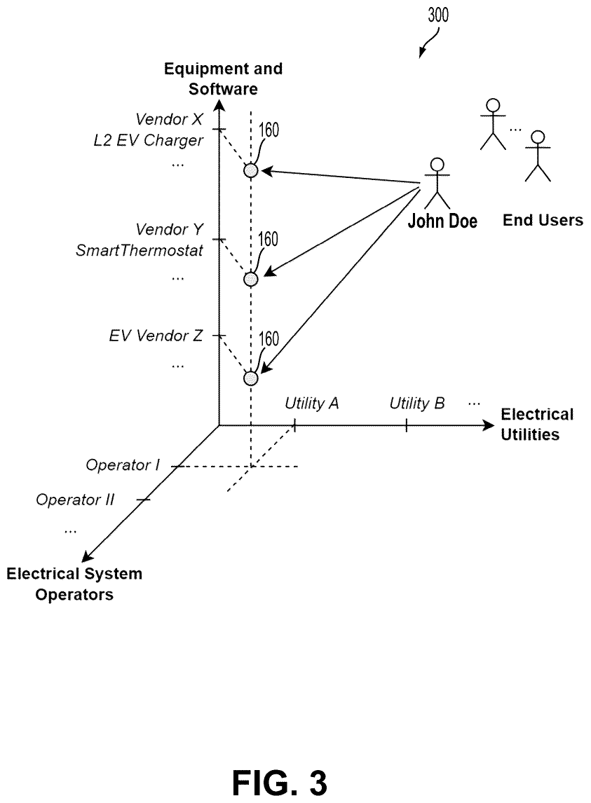

FIG. 3 is a graph of a three-dimensional (3D) space used to represent the relationship between end users, assets (equipment and software), electrical system operators, and electrical utilities, in accordance with an embodiment. As depicted, an asset (e.g., an end user asset 170) is represented as a point within this 3D space.

As depicted, an example user John Doe may operate three end user assets 170, namely, a Level 2 EV charger purchased from Vendor X installed at the user's home, an EV purchased from Vendor Z, and a smart thermostat purchased from Vendor Y which is used to control heat, air conditioning, humidity in the user's home. John Doe's home is located within Utility A's service network, where Utility A is under Operator I's administrative jurisdiction. In this example, the disparate assets from Vendor X, Y, and Z may each communicate according to disparate protocols, data formats, and/or communication interfaces. Thus, for an electrical utility (such as Utility A) to coordinate with each of these end user asset 170, the utility would need to adapt its computing system (e.g., utility computing device 150) for data communication compatibility with each of the user assets 170. This may be time-consuming, expensive, and/or uneconomical.

As detailed herein, in some embodiments, management system 200 manages data communication between the various entities shown in FIG. 3. For example, management system 200 may provide translation to facilitate data communication between an electrical utility or an electrical system operator.

In some embodiments, management system 200 may store an electronic data record with data representing each data point of the graph 300 of FIG. 3, e.g., representing the relationship between specific ones of end users, equipment and software, electrical system operators, and electrical utilities. In some embodiments, such data records may also include additional user metadata such as user preferences or requirements, which may be taken into account during operation of management system 200, e.g., when requesting curtailment actions.

In the above example, an example residential user (John Doe) is described. However, various other types of end users may be represented in graph 300 and represented in data stored at management system 200. In another example, an end user may be an EV fleet owner that operates a large number of EVs and/or chargers. In yet another example, an end user may be an EV charger depot operator that operates EV charging stations across different locations. In other examples, the end users may be various other types of residential, commercial, or industrial users.

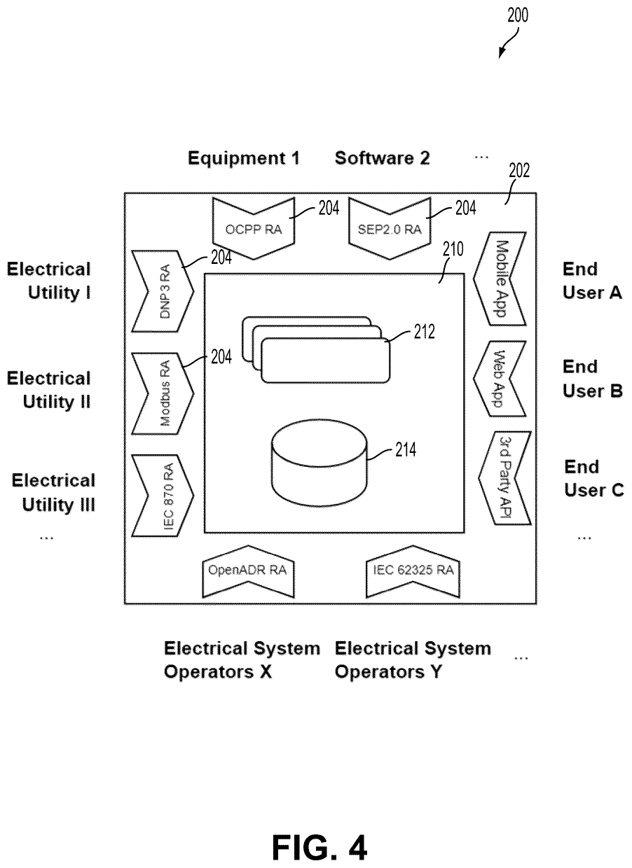

FIG. 4 is a schematic diagram of management system 200, in accordance with an embodiment. As depicted, management system 200 includes a translation layer 202 and a logic core 210.

Translation layer 202 is configured to translate data communications according to a plurality of disparate protocols, data formats and communication interfaces, each as may be used by one or more of disparate system operator computing devices 140, disparate electrical utility computing devices 150, disparate electrical utility assets 160, disparate end user assets 170, and so on.

As depicted, translation layer 202 may include a plurality of resource adapters 204. Each resource adapter 204 is configured to support a particular type of communication interface, a particular data format, and/or a particular communication protocol. Management system 200 may communicate with a particular operator computing device 140, a particular utility computing device 150, a particular electrical utility asset 160, and a particular end user assets 170 by way of a suitable one of the resource adapters 204. Management system 200 may automatically select the appropriate resource adapter to use for each desired communication.

In one example, management system 200 may communicate with a particular Equipment 1 that uses OCPP for data communication by translating communication messages using a resource adapter 204 configured to translate messages to/from OCPP. In another example, management system 200 may communicate with a particular Electrical Utility I that uses Modbus for data communication by translating communication messages using a resource adapter 204 configured to translate messages to/from Modbus. Other types of resource adapters 204 are depicted in FIG. 4.

In some embodiments, a resource adapter 204 may expose a particular interface (such as web interface, an API, or the like) suitable for data communication with a particular entity. In some embodiments, a resource adapter 204 may expose a particular network port (or ports) suitable for data communication with a particular entity.

In some embodiments, a resource adapter 204 may be configured to facilitate communication with computing devices, equipment and/or software of a power generating plant 108.

Logic core 210 includes one or more logic modules 212 configured to implement business logic functionality. For example, these logic modules 212 may include a logic module 212 that performs load prediction, a logic module 212 that generates recommendations for rewards to end users for performing requested curtailment actions, a logic module 212 that generates curtailment plans, etc. In various embodiments, various logic modules 212 may be included in logic core 210, depending on the needs of system operators, electrical utilities, and end users.

Logic core 210 also includes an electronic datastore 214. Electronic data store 214 may include a combination of non-volatile and volatile memory. In the depicted embodiment, electronic datastore 214 is organized as a data lake suitable for storing various types of structured, semi-structured, or unstructured data. Data stored in a data lake may include, for example, user preferences/requirements, status of various electrical utility assets 160, statuses of various end user assets 170, etc.

In some embodiments, electronic datastore 214 may be organized as a database. Such database may be a conventional relational database such as a SQL-based database, an object-oriented database, a NoSQL database, or the like.

In some embodiments, a resource adapter 140 may translate an inbound data communication (received at management system 200) into an input usable by a particular module 212. In some embodiments, the input format may adhere to a data schema specification associated with that module 212. In some embodiments, a resource adapter 140 may translate an outbound data communication (to be sent by management system 200) from an output of a particular module 212.

In some embodiments, translation layer 202 may implement a modular architecture that allows resource adapters 204 to be added and/or removed from translation layer during operation of management system 200. In this way, management system 200 may be adjusted dynamically (e.g., during run-time) to support new types of assets, new communication interfaces/protocols, or the like.

In some embodiments, translation layer 202 may implement a modular architecture that allows logic modules 212 to be added and/or removed from logic core 210. In this way, the business logic of management system 200 may be adjusted dynamically (e.g., during run-time) to support new modules 212.

Translation layer 202 and logic core 210 (including logic modules 212) may be implemented using a suitable combination of software and hardware components. Software components may be implemented using conventional programming languages such as Java, J#, C, C++, C#, Perl, Visual Basic, Ruby, Scala, etc. These software components may be in the form of one or more executable programs, scripts, routines, statically/dynamically linkable libraries, or the like.

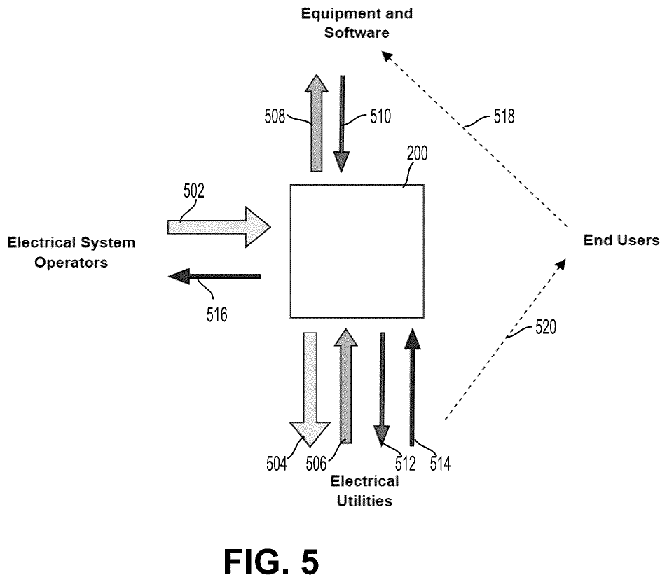

FIG. 5 depicts flow of data transmissions to and from management system 200, in accordance with an embodiment.

From time to time, an electrical system operator may determine a likelihood of a power shortfall within an electrical power system, due to increasing demand or decreasing supply, as may result for example, from extreme weather conditions, social activities, unavailability of generation/transmission equipment, and so on.

The electrical system operator may initiate load curtailment to avoid a power shortfall by reducing demand or otherwise shaping the demand. An operator computing device 140 operated by that electrical system operator sends a data transmission 502 encoding a load curtailment request to management system 200.

Management system 200 processes the load curtailment request and performs any required translation using translation layer 202. For example, translation layer 202 may translate the load curtailment request into a data format and/or protocol suitable for one or more electrical utilities within scope of the curtailment request. Management system 200 sends one or more data transmission 504 to corresponding one or more utility computing devices 150 operated by the respective electrical utilities. Each data transmission 504 encodes at least a portion of the curtailment request relevant to the target electrical utility.

Upon receipt of a data transmission 504, an electrical utility decides whether to approve or reject the curtailment request. If the request is approved, the utility computing device 150 operated by that electrical utility sends a data transmission 506 to management system 200. Data transmission 506 encodes a curtailment plan that includes a plurality of action requests for a plurality of end user assets 170. Each action request includes a desired action in support of the requested curtailment (e.g., to reduce demand by adjusting a thermostat setpoint or pausing EV charging, to draw power from a BESS, or the like.) In some embodiments, the curtailment plan also includes a plurality of action request for a plurality of electrical utility assets 160. In some embodiments, a curtailment plan is received by management system 200 from an operator computing device 140. In some embodiments, a curtailment plan is generated at management system 200.

Management system 200 may receive multiple curtailment plans from multiple electrical utilities subject of a curtailment request. Each curtailment plan includes action requests for assets within a particular electrical utility's service scope.

Management system 200 processes the load curtailment request to perform any required translation using translation layer 202. For example, translation layer 202 may translate the load curtailment request into a data format and/or protocol suitable for each end user asset 170 or electrical utility asset 160 subject of a particular action request. Management system 200 sends one or more data transmissions 508 to corresponding one or more end user asset 170 and electrical utility asset 160. Each data transmission 508 encodes the action request for the target asset.

Management system 200 receives one more data transmissions 510 from the one or more end user asset 170 and the one or more electrical utility asset 160. Each data transmission 510 encodes a response to the action request. The response may contain data indicating whether the response has been accepted, rejected, acted upon in part, or other feedback. Management system 200 processes each response to perform any required translation using translation layer 202.

Management system 200 sends one or more data transmissions 512 to an electrical utility device 150. Each data transmission 512 encodes information regarding one or more responses received from end user assets 170 or electrical utility assets 160. In some embodiments, each data transmission 512 aggregates responses from multiple end user assets 170 and/or electrical utility assets 160.

Management system receives a data transmission 514 from an electrical utility device 150. Data transmission 514 encodes aggregated confirmation/feedback responsive to the curtailment request. Management system may processes this confirmation/feedback to perform any required translation using translation layer 202.

Management system sends a data transmission 516 to the particular operator computing device 140 that initiated the load curtailment request. Data transmission 516 encodes the aggregated confirmation/feedback received from the electrical utility device 150. In some embodiments, data transmission 516 may aggregate confirmation/feedback from multiple electrical utility device 150 (as may be operated by multiple electrical utilities).

As represented by link 518, an end user may specify his/her own power consumption preferences or requirements for one or more end user assets 170. Such preferences or requirements may influence how the end user asset 170 responds to an action request. Such preferences or requirements may be inputted remotely by an end user via smart home software or directly at the particular end user asset 170.

As represented by link 520, electrical utilities may reward end users for their responses to curtailment requests, e.g., in the form of fee discounts, rebates, or other rewards. In some embodiments, electrical utilities may provide a reward based on a reward recommendation generated by management system 200. In such embodiments, logic modules 212 may include a reward recommendation module that analyzes a particular end user's compliance with curtailment requests. Such analysis may take into account an end user's behaviour over a period of time, or over a set of assets operated by that end user.

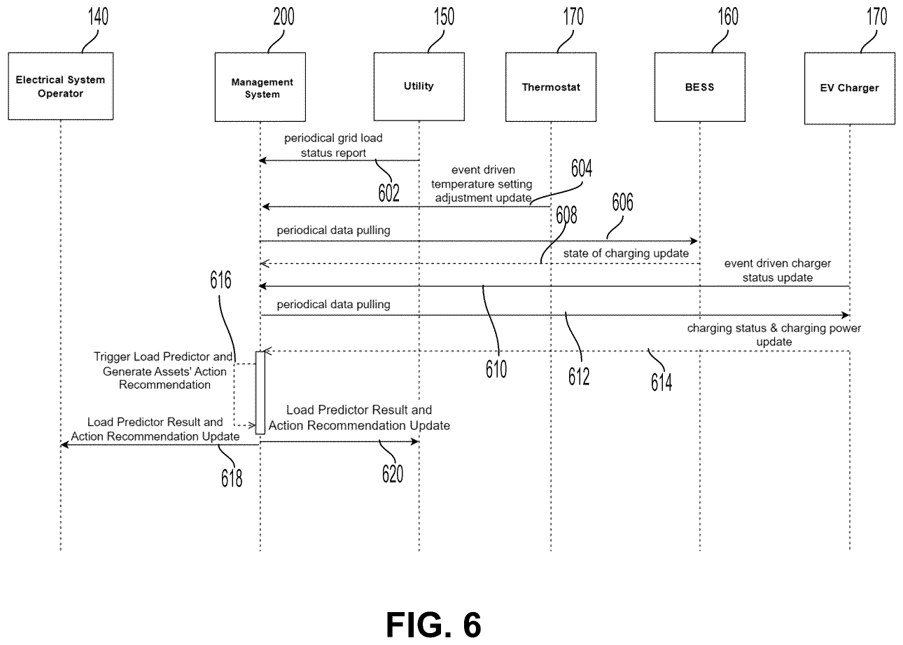

FIG. 6 depicts a sequence of events that may occur during operation of management system 200. As shown in this sequence, management system 200 receives data informative of expected power demand and expected power supply from various entities within an electrical power system.

In particular, management system 200 receives periodic grid load status reports from an electrical utility device 150, which may include information on expected power that can be supplied by an electrical utility in a given time period (event 602).

Management system 200 also receives data informative of expected power demand from various end user assets 170. In one example, management system 200 may receive information from a smart thermostat regarding temperature setpoint adjustments (event 604). This information may be provided by the smart thermostat whenever the setpoint changes. In another example, management system 200 may receive information from an EV charger regarding charge status changes (e.g., whenever an EV starts or stops charging, or whenever there is a change in an charging schedule). In some cases, this information may be provided by the EV charger whenever the status or schedule changes (event 610). In some cases, management system 200 may request an update from the EV charger (event 612) and the EV charger may provide the requested information in response (event 614).

Management system 200 also receives data informative of statuses of BESSs (operated by an end user or by an electrical utility). In one example, management system 200 may receive information from an electrical utility asset 160 that is a FOTM BESS regarding its state of charge. In some cases, this information may be provided by the BESS whenever charging state changes. In some cases, management system 200 may request an update from the BESS (event 606) and the EV charger may provide the requested information in response (event 608).

In the depicted embodiment, management system 200 processes the data received from various entities in the electrical power system and makes a load prediction for a given time period. In such embodiments, logic modules 212 may include a load predictor module configured to generate the load prediction. In some embodiments, the load predictor module may include a load predictor as disclosed in International Patent Publication No. WO2024086937A1, entitled “Methods and systems for controlling electric vehicle charging based on power distribution system information”, the entire contents of which is hereby incorporated by reference.

Management system 200 also takes into account information regarding predicted supply in the given time period, as may be communicated by an electrical utility computing device 150. By comparing predicted supply and predicted load, management system 200 can determine the existence of an anticipated shortfall. Based on this, management system 200 can generate a recommendation for curtailment. In some embodiments, management system 200 generates a recommendation for curtailment in manners similar to those disclosed in International Patent Publication No. WO2024086937A1. The recommendation and/or the load prediction is communicated by management system 200 to the operator computing device 140 (event 618) and the utility computing device 150 (event 620).

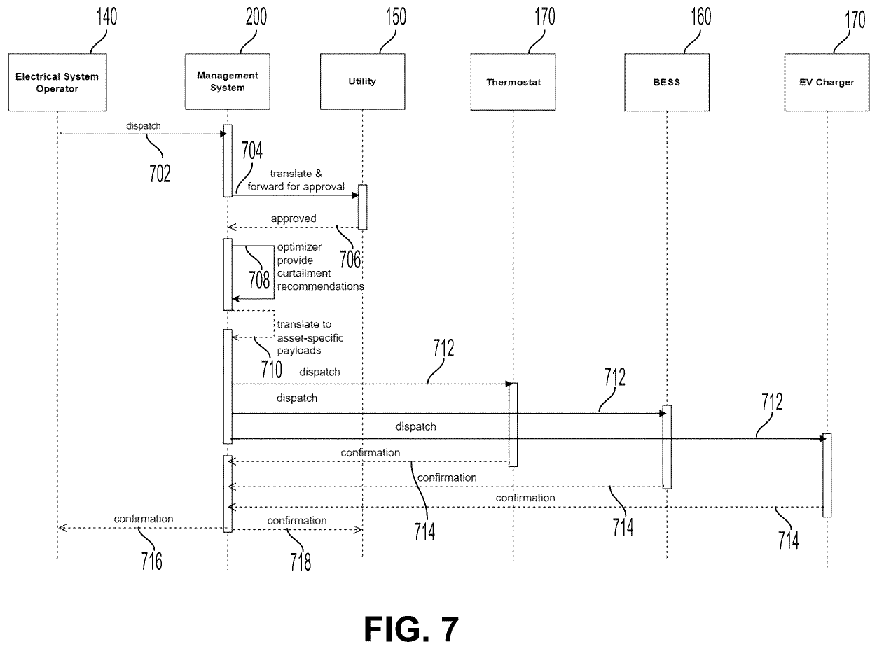

The operation of management system 200 may be further described with reference to the sequence diagram of FIG. 7, in accordance with an embodiment.

FIG. 7 depicts a sequence of events that may occur during operation of management system 200. The sequence of events begin when an electrical system operator decides to initiate load curtailment. An operator computing device 140 of that electrical system operator dispatches a load curtailment request to management system 200 (event 702).

The load curtailment request may be expressed in an XML format in accordance with the OpenADR protocol. An example request is as follows:

```
<oadrPayload xmlns=“http://openadr.org/oadr-2.0b”>
  <oadrSignedObject>
    <oadrDistributeEvent>
      <Response>
        <responseCode>200</responseCode>
      </Response>
      <requestID>123456</requestID>
      <oadrEvent>
        <Target> Utility A</Target>
        <EventSignals ... </EventSignals>
      </oadrEvent>
    </oadrDistributeEvent>
  </oadrSignedObject>
</oadrPayload>
```

The request encodes, for example, a numeric identifier (i.e., requestID) for a curtailment request and a target electrical utility (i.e., Utility A).

Management system 200 translates the curtailment request and forwards at least a portion of the load curtailment request to a utility computing device 150 (event 704) of an electrical utility subject of the curtailment request.

If the electrical utility decides to comply with the curtailment request, the utility computing device 150 communicates an approval to management system 200 (event 706).

In the depicted embodiment, management system 200 generates a curtailment plan to implement the load curtailment request (event 708). In such embodiment, logic modules 212 includes a curtailment plan generation module configured to generate a curtailment plan. Such curtailment plan generation module may generate a load curtailment plan to include action requests corresponding to the disparate end user assets 170 within the scope of the load curtailment request. Each action request may include a curtailment recommendation for an end user asset 170 (e.g., to reduce demand by adjusting a thermostat setpoint or pausing EV charging, to draw power from a BESS, or the like.)

The curtailment plan generation module may also generate a curtailment plan that includes action requests corresponding to the disparate electrical utility assets 160 within the scope of the load curtailment request such as various batteries, transformers, substations, feeders, etc. Each such action requests includes an action intended to support the curtailment request.

The curtailment plan generation module may generate the curtailment plan using an optimizer that takes into account various relevant factors. One factor is the amount of power demand to be reduced. Other factors include statuses of various end user asset 170 and electrical utility assets 160 (e.g., the battery levels of EVs or BESSs, or related discharge/charge schedules). Other factors include user preferences/requirements, e.g., as expressed via link 518 (FIG. 5).

To generate the curtailment plan, the optimizer may implement a cost function. The cost function may model a monetary cost, a user satisfaction cost, or a combination these and other relevant costs. The cost function may be minimized using an appropriate algorithm or model to minimize the cost function such as, e.g., linear programming, constrained optimization, gradient based optimization, particle swarm optimization, or the like.

Referring again to FIG. 7, management system 200 translates each action request for a particular end user asset 170 or electrical utility assets 160 into a protocol or format with a payload specific to that asset (event 710). Three examples are depicted: an action request for end user asset 170 that is a smart thermostat, an action request for end user asset 170 that is an EV charger, and an action request for an electrical utility asset 160 that is a FOTM BESS. Example payloads for these action requests are as follows.

Example payload for a smart thermostat:

```
{“selection”: {
  “selectionType”: “registered”,
  “selectionMatch”: “”,
  “includeSettings”: true
  },
“functions”: [
{
  “type”: “setHold”,
  “params”: {
  “holdType”: “nextTransition”,
  “heatHoldTemp”: 20,
  “coolHoldTemp”: 22,
  “holdClimateRef”: “away”
}}]}
```

The payload encodes a request to hold temperate settings at particular setpoints. This example payload is formatted in adherence to an API used by Ecobee™ smart thermostats.

Example payload for an EV charger:

{
“messageTypeId”: “StopTransaction”,
“uniqueId”: “123456789”,
“connectorId”: 1,
“transactionId”: 987654321,
“timestamp”: “2024-04-14T12:00:00Z”,
“reason”: “Local”,
“idTag”: “ABC123DEF456”
}

The payload encodes a request to stop a going on charging session with id 987654321 at specific timestamp 2024-04-14T12:00:00Z. The payload is formatted in adherence to the OCPP protocol.

Example payload for a FOTM BESS:

```
“timestamp”: 1643214000, “metrics”: [
  {“name”: “frequency_setpoint”, “dataType”: “FLOAT”,
  “value”: 60.0},
  {“name”: “time_sync”, “dataType”: “BOOLEAN”,
  “value”: true},
  {“name”: “charge_limit”, “dataType”: “FLOAT”,
  “value”: 80.0}]}
```

The payload encodes a request to config a BESS to report its state of charging every 60 seconds, and the BESS's charge limit is set to 80%. This example payload is formatted in adherence to the MQTT protocol.

Management system 200 dispatches each action request (with its payload) to the three targeted assets (events 712). Management system 200 receives confirmations/feedback from each of the targeted assets (events 714). Management system 200 sends aggregated confirmation/feedback to operator computing device 140 (event 716). Management system 200 sends aggregated confirmation/feedback to electrical utility computing device 150 (event 718).

It should be understood that events depicted in FIG. 6 and FIG. 7 may occur in a different sequence or in an interleaved or iterative manner. Further, variations of the events, omission or substitution of various events, or additional events may be considered.

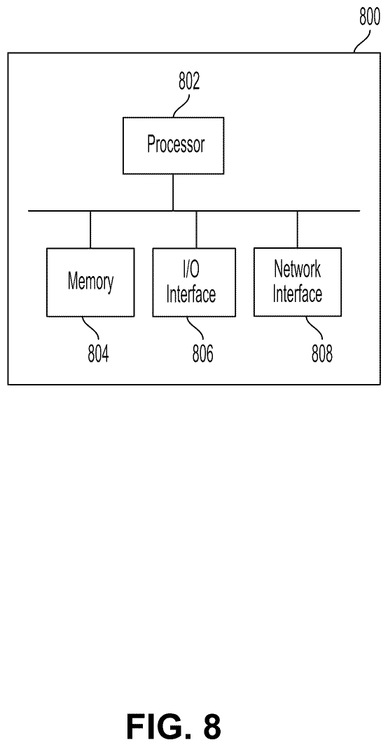

FIG. 8 is a schematic diagram of computing device 800 which may be used to implement management system 200, in accordance with an embodiment.

As depicted, computing device 800 includes a processing subsystem with one or more processors 802, one or more memories 804, and a communication subsystem with one or more I/O interfaces 806, and one or more network interfaces 808.

Each processor 802 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 804 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 806 enables computing device 800 to interconnect with one or more input devices, such as a keyboard, mouse, camera, touch screen and a microphone, or with one or more output devices such as a display screen and a speaker.

Each network interface 808 enables computing device 800 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

For simplicity only, one computing device 800 is shown but management system 200 may include multiple computing devices 800. The computing devices 800 may be the same or different types of devices. The computing devices 800 may be connected in various ways including directly coupled, indirectly coupled via a network, and distributed over a wide geographic area and connected via a network (which may be referred to as “cloud computing”).

For example, a computing device 800 may be a server, network appliance, set-top box, embedded device, computer expansion module, personal computer, laptop, personal data assistant, cellular telephone, smartphone device, UMPC tablets, video display terminal, gaming console, or any other computing device capable of being configured to carry out the methods described herein.

In some embodiments, a computing device 800 may implement an electrical system operator computing device 140. In some embodiments, a computing device 800 may implement an electrical utility computing devices 150.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which may be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A computer-implemented system for managing data communication in an electrical power system, the system comprising:
a communication subsystem including one or more network interfaces for communication via one or more communication networks; and
a processing subsystem that includes one or more processors and one or more memories coupled with the one or more processors, the processing subsystem configured to cause the system to:
provide a translation layer for translating communications according to a plurality disparate protocols used by a plurality of disparate end user assets;
receive a load curtailment plan to implement a load curtailment request from an electrical system operator, the load curtailment plan including a plurality of action requests corresponding to at least one of the disparate end user assets;
translate the action requests using the translation layer; and
transmit the translated action requests, via the communication subsystem, to the at least one of the disparate end user assets.

2. The computer-implemented system of claim 1, wherein the translation layer is configured to translate communications with a plurality of the electrical system operators.

3. The computer-implemented system of claim 1, wherein the translation layer is configured to translate communications with a plurality of electrical utilities.

4. The computer-implemented system of claim 1, wherein the translation layer is configured to translate communications with a plurality of electrical utilities assets.

5. The computer-implemented system of claim 1, where the processing subsystem is further configured to cause the system to:
receive from electrical system operator a load curtailment request.

6. The computer-implemented system of claim 5, where the processing subsystem is further configured to cause the system to:
generate the load curtailment plan responsive to the load curtailment request.

7. The computer-implemented system of claim 5, where the processing subsystem is further configured to cause the system to:
translate, using the translation layer, at least a portion of the load curtailment request for communication to an electrical utility.

8. The computer-implemented system of claim 7, where the processing subsystem is further configured to cause the system to:
transmit the at least a portion of the load curtailment request, as translated, to the electrical utility via the communication subsystem.

9. The computer-implemented system of claim 1, where the processing subsystem is further configured to cause the system to:
receive a status update from a given one of the end user assets.

10. The computer-implemented system of claim 1, wherein the plurality of disparate end user assets includes one or more of:
disparate types of electric vehicles;
disparate types of electric vehicle chargers;
disparate types of distributed energy resources;
disparate types of smart thermostats; and
disparate types of smart home software.

11. The computer-implemented system of claim 1, where the translation layer is further configured to translate communications according to a plurality disparate protocols used by a plurality of disparate electrical utility assets.

12. The computer-implemented system of claim 1, where the curtailment plan further includes a plurality of action requests corresponding to one or more disparate electrical utility assets.

13. A computer-implemented method for managing communication with an electrical power system, the method comprising:
receiving a load curtailment plan to implement a load curtailment request from an electrical system operator, the load curtailment plan including a plurality of action requests corresponding to one or more disparate end user assets;
translating the action requests for communication in accordance with a plurality disparate protocols used by the one or more disparate end user assets; and
transmitting the translated action requests to the one or more disparate end user assets.

14. The computer-implemented method of claim 13, further comprising:
receiving from electrical system operator a load curtailment request.

15. The computer-implemented method of claim 14, further comprising:
generating the load curtailment plan responsive to the load curtailment request.

16. The computer-implemented method of claim 13, further comprising:
translating at least a portion of the load curtailment request for communication to an electrical utility.

17. The computer-implemented method of claim 16, further comprising:
transmitting the at least a portion of the load curtailment request, as translated, to the electrical utility.

18. The computer-implemented method of claim 13, further comprising:
receiving a status update from a given one of the end user assets.

19. The computer-implemented method of claim 13, wherein the plurality of disparate end user assets includes one or more of:
disparate types of electric vehicles;
disparate types of electric vehicle chargers;
disparate types of distributed energy resources;
disparate types of smart thermostats; and
disparate types of smart home software.

20. The computer-implemented method of claim 13, where the curtailment plan further includes a plurality of action requests corresponding to one or more disparate electrical utility assets.
